(19) United States
(12) Patent Application Publication
(10) Pub. No.: US 2009/0096313 A1
(43) Pub. Date: Apr. 16, 2009

(54) STATOR FOR ROTATING ELECTRICAL MACHINE, PART TO BE USED FOR STATOR AND METHOD FOR MANUFACTURING STATOR FOR ROTATING ELECTRICAL MACHINE

(75) Inventors: Kenji Harada, Aichi-ken (JP); Yasuji Taketsuna, Aichi-ken (JP); Shingo Fubuki, Aichi-ken (JP)

Correspondence Address: SUGHRUE MION, PLLC, 2100 PENNSYLVANIA AVENUE, N.W., SUITE 800, WASHINGTON, DC, 20037, US

(73) Assignee: TOYOTA JIDOSHA KABUSHIKI KAISHA, Toyota-shi (JP)

(21) Appl. No.: 12/282,585

(22) PCT Filed: Mar. 16, 2007
(86) PCT No.: PCT/JP2007/056135

§ 371 Date: Sep. 11, 2008

(30) Foreign Application Priority Data
Mar. 22, 2006 (JP) 2006-078680

(51) Int. Cl. H02K 23/26; H02K 15/06

(52) U.S. Cl. 310/201; 29/596; 977/932

(57) ABSTRACT

A stator includes a stator core having a plurality of slots in a direction parallel to the rotating shaft of a rotating electrical machine; and a coil plate laminated body formed by laminating a plurality of I-shaped coil plates, each of which has an insulating film adhered at least on one side, in a diameter direction. In the coil plate laminated body, a plurality of coil plates are inserted inside a resin insulator inserted into the slots so that the insulating film is arranged between the coil plates, and the coil plates are integrally held by the resin insulator. The resin insulator integrally holds the coil plate laminated body of a plurality of phases in the same slot.

### TECHNICAL FIELD

The present invention relates to a stator for a rotating electrical machine, a part to be used for the stator, and a method for manufacturing the stator for the rotating electrical machine. In particular, the present invention relates to a stator having a structure for improving insulating performance and productivity, a part to be used for the stator, and a method for manufacturing the stator.

### BACKGROUND ART

As a stator for a rotating electrical machine including the stator and a rotor, conventionally, there has been disclosed a stator formed in such a manner that an integral laminated coil is inserted into a slot between a plurality of teeth provided in a stator core. In the integral laminated coil, for example, two sets of coil laminated bodies each having a plurality of linear and thin conductors laminated are integrally formed by resin molding. The thin conductors are laminated so as to be close to a sectional area of the slot in a direction orthogonal to a rotating shaft, so that an area ratio of a sectional area occupied by the coil to a sectional area of the slot (hereinafter, referred to as a space factor) can be improved. With regard to a structure of the stator for the rotating electrical machine described above, there is a technique disclosed in the following publication.

For example, Japanese Patent Laying-Open No. 2001-178053 discloses a stator for a rotating electrical machine which can be reduced in size and improved in workability in such a manner that a length of a coil end is reduced. The stator for the rotating electrical machine includes a stator core, and stator coils attached to a plurality of slots formed between teeth of the stator core. The stator coil is formed in such a manner that two sets of linear and thin conductors, which are laminated, are integrally molded into one by an insulating resin. The stator coil is constituted of a laminated coil piece having connection ends formed at two ends of the conductor, and first and second connection coil pieces formed in such a manner that laminated thin conductors are integrally molded into one by an insulating resin. In the thin conductors of the laminated coil piece inserted into the plurality of slots of the stator core with the tooth being interposed therebetween, one ends are connected by the thin conductors of the first connection coil piece so as to hold the tooth, and the other ends are connected by the thin conductors of the second connection coil so as to hold the tooth with the thin conductors laminated in a radial direction of the stator core being displaced one by one in the radial direction. The stator has a feature in that the stator coil is formed while being wound around the tooth as described above.

The stator for the rotating electrical machine disclosed in this publication can be reduced in size and improved in workability in such a manner that the length of the coil end is reduced.

In the stator for the rotating electrical machine disclosed in the foregoing publication, however, if the space factor is further enhanced, there arises a problem that the insulating performance can not be ensured sufficiently. The stator coil disclosed in the foregoing publication is formed in such a manner that the thin conductors are laminated with a gap being interposed therebetween and, then, are integrally molded while being filled with a resin. Consequently, if the gap is further decreased for enhancing the space factor, there is a possibility that the gap can not be filled with the resin having a certain viscosity.

In the case where the laminated coils are integrally molded, further, if the gap between the thin conductors is further decreased, a correcting operation such as an operation for cutting the resin protruding in the resin molding must be performed occasionally. The reason therefor is as follows. For example, in the case where the laminated coils are integrally molded, a portion other than an end of the coil is molded while covering the end of the coil. However, as the gap becomes smaller, a possibility that the resin protrudes from the cover becomes higher. Consequently, there arises a problem that workability deteriorates.

Further, the thin conductors are joined in such a manner that a base material is melted by welding. The thin conductor is made of a material, such as copper, which is high in heat conductivity. Therefore, the joint portion must be welded while being heated at a high temperature (about 1000° C.). When the joint portion reaches the high temperature, an insulating member such as a resin is melted by the heat generated in the welding and transmitted from the thin conductor, and is degraded occasionally. There is no inexpensive organic material which can be molded and is not melted even at a high temperature; consequently, a problem that insulating performance becomes deteriorated is inevitable.

Moreover, if a joining material which is low in heating temperature (about 350° C.) in a joining process such as soldering is used for preventing the insulating member from being melted, there is a possibility that the heat (about 200° C.) generated upon actuation of the rotating electrical machine deteriorates a joining strength of the joining material. The reason therefor is that a low melting point material is typically high in interdiffusion with copper to generate a brittle intermetallic compound.

In the stator for the rotating electrical machine disclosed in the foregoing publication, further, the end of the coil is subjected to a cutting process after completion of the integral molding process to form a connection terminal. Consequently, there is a possibility that the insulation is damaged due to burrs or powders resulting from the cutting process.

### DISCLOSURE OF THE INVENTION

An object of the present invention is to provide a stator for a rotating electrical machine capable of achieving both improvement of a space factor and insulation between coil turns, a part to be used for the stator, and a method for manufacturing the stator. Another object of the present invention is to provide a stator for a rotating electrical machine capable of suppressing deterioration of workability, and a method for manufacturing the stator. Still another object of the present invention is to provide a stator for a rotating electrical machine capable of suppressing deterioration of insulating performance due to heat generated in a joining process, and a method for manufacturing the stator.

A part to be used for a stator according to one aspect of the present invention includes “I”-shaped coil plates each having at least one side to which a first insulating member is attached. The part is formed in such a manner that the plurality of coil plates each of which is inserted into a single slot of a stator core are laminated and, further, the plurality of laminated coil plates are held by a second insulating member.

According to the present invention, the part to be used for the stator (e.g., a coil sub-assy) is formed as follows. That is, the plurality of coil plates inserted into the single slot of the stator core are laminated and, further, the plurality of laminated coil plates are held by the second insulating member. For example, a thickness of the first insulating member attached to at least one side of the coil plate is set to be not less than a distance capable of ensuring insulation between the coil plates, so that insulating performance between the coil plates can be ensured with certainty by interposition of the first insulating member. Therefore, when the thickness of the first insulating member is made thin as much as possible while ensuring the insulating performance, a space factor can be enhanced without deterioration of the insulating performance. Accordingly, it is possible to provide a part to be used for a stator for a rotating electrical machine capable of achieving both improvement of a space factor and insulation between coil turns.

A stator according to another aspect of the present invention is a stator for a rotating electrical machine including a rotor and the stator. The stator includes a stator core having a plurality of slots in a direction parallel with a rotating shaft of the rotating electrical machine, and a coil plate laminated body formed in such a manner that a plurality of “I”-shaped coil plates each having at least one side to which a first insulating member is attached are laminated in a radial direction. The coil plate laminated bodies are integrally held by a second insulating member inserted into the slot in such a manner that the plurality of coil plates are inserted into the second insulating member with the first insulating member being interposed therebetween. The second insulating member integrally holds the multi-phase coil plate laminated bodies in the single slot.

According to the present invention, the plurality of “I”-shaped coil plates each having at least one side to which the first insulating member (e.g., an insulating film) is attached are laminated with the first insulating member being interposed therebetween. The plurality of laminated coil plates are integrally held by the second insulating member. The second insulating member integrally holds the multi-phase coil plate laminated bodies in the single slot. For example, a thickness of the first insulating member is set to be not less than a distance capable of ensuring insulation between the coil plates, so that insulating performance between the coil plates can be ensured with certainty by interposition of the first insulating member. Therefore, when the thickness of the first insulating member is made thin as much as possible while ensuring the insulating performance, a space factor can be enhanced without deterioration of the insulating performance. Accordingly, it is possible to provide a stator for a rotating electrical machine capable of achieving both improvement of a space factor and insulation between coil turns. Further, the coil plates are inserted into the second insulating member, so that the laminated coil plates are held integrally, leading to further insulation between the coil plate and the stator core. In comparison with a case where the laminated coil plates are integrally molded by a resin, therefore, it is unnecessary to perform a correcting operation such as an operation for cutting a protruding resin. Accordingly, it is possible to provide a stator for a rotating electrical machine which suppresses deterioration of workability. Moreover, the coil plate laminated bodies are integrally held by the second insulating member. Therefore, it is possible to inspect an insulating state between the laminated coil plates prior to insertion of the second insulating member into the slot, leading to improvement of reliability of insulation between the turns. Further, the second insulating member integrally holds the multi-phase coil plate laminated bodies inserted in the single slot. Therefore, it is possible to inspect an insulating state between the coil plate laminated bodies prior to insertion of the second insulating member into the slot, leading to improvement of reliability of insulation between the phases. Further, it is possible to inspect insulating performance of the second insulating member prior to insertion of the second insulating member into the slot, leading to improvement of reliability of insulation between the coil plate and the stator core. Moreover, it is possible to inspect an insulating state between the coil plate laminated bodies held by the second insulating member prior to incorporation into the stator core, leading to improvement of workability. Further, the coil plate is formed into the “I” shape by, for example, a shearing process or the like, leading to improvement of a yield. Further, there is no necessity of cutting a coil end after incorporation into the stator core; therefore, it is possible to suppress damage of insulation caused due to burrs or powders resulting from the cutting process.

Preferably, the stator further includes a connection member which connects between the coil plate laminated bodies inserted into the different slots. A paste-like joining material containing a metal nanoparticle coated with an organic substance and an organic solvent joins between the coil plate and the connection member.

According to the present invention, the joint portion between the ends of the coil plates and the connection members (e.g., a transition member and a bus bar) is joined with the use of the paste-like joining material containing the metal nanoparticle coated with the organic substance and the organic solvent. In the joining material, when the organic substance serving as a protective layer is decomposed by application of heat, the metal nanoparticle is sintered at a low temperature. Therefore, the sintering temperature can be set to be lower than a melting temperature of an insulating material. On the other hand, after the sintering, the metal nanoparticle is in a metal bonding state, and is not melted until the temperature approaches a eutectic temperature between metal and a material for the coil plate (e.g., about 1000° C. in a case of silver and copper). When the joint portion is joined with the use of the joining material described above, the temperature in the joining process becomes lower than the melting temperature of the insulating material, leading to suppression of deterioration of insulating performance of the insulating member. After the joining process, further, the melting temperature of the joint portion becomes sufficiently higher than the heat generated upon actuation of the rotating electrical machine, leading to suppression of deterioration of a joining strength. Accordingly, it is possible to provide a stator for a rotating electrical machine which suppresses deterioration of insulating performance due to heat generated in a joining process.

More preferably, the joining material is sintered at a temperature lower than a melting temperature of an insulating material used for the stator.

According to the present invention, the joining material is sintered at the temperature lower than the melting temperature of the insulating material used for the stator. Therefore, there is no possibility that the stator is heated in the joining process until the insulating material is melted. Hence, it is possible to suppress deterioration of insulating performance due to heat generated in a joining process.

More preferably, the metal nanoparticle is a nanoparticle of metal selected from gold, silver, copper and platinum.

According to the present invention, use of the paste-like joining member containing the nanoparticle of metal selected from gold, silver, copper and platinum prevents the stator from being heated in the joining process until the insulating material is melted. Hence, it is possible to suppress deterioration of insulating performance in a joining process.

More preferably, the first insulating member is any one of an insulating film and a coating film of insulation coating.

According to the present invention, the coil plates are laminated with one of the insulating film and the coating film of insulation coating being interposed therebetween, so that the coil plates can be insulated from each other with more certainty by the insulating film or the coating film. Moreover, thicknesses of the insulating film and the coating film are made thin as much as possible, leading to improvement of both insulating performance and a space factor.

More preferably, the second insulating member is formed into a hollow shape which contacts with an inner wall face of the slot and extends in a direction parallel with the rotating shaft, and is formed into a predetermined shape by a resin.

According to the present invention, the second insulating member is formed into the hollow shape which contacts with the inner wall face of the slot and extends in the direction parallel with the rotating shaft. Since the “I”-shaped coil plate is inserted into the second insulating member, the insulation between the coil plate and the stator core can be ensured with more certainty by the second insulating member. Moreover, use of the metal nanoparticle paste as the joining material eliminates a necessity of heating to a higher temperature in the joining process, so that a resin which is excellent in moldability can be used.

More preferably, the coil plate laminated body includes a plurality of coil plates laminated in the radial direction.

According to the present invention, a leakage flux, which traverses in the slot in a circumferential direction, is generated occasionally under a high load. When the coil plates are laminated in the radial direction, a width direction of the coil plate can be made substantially parallel with the direction of the leakage flux, leading to suppression of generation of eddy current. Accordingly, it is possible to suppress loss due to generation of eddy current.

More preferably, the coil plate laminated body includes a plurality of coil plates laminated such that a width direction of the coil plate is orthogonal to a wall face in the slot in a circumferential direction.

According to the present invention, a leakage flux, which traverses in the slot in a circumferential direction, is generated occasionally under a high load. When the coil plates are laminated such that the width direction of the coil plate is orthogonal to the wall face in the slot in the circumferential direction, the width direction of the coil plate can be made substantially parallel with the direction of the leakage flux, leading to suppression of generation of eddy current. Accordingly, it is possible to suppress loss due to generation of eddy current.

A method for manufacturing a stator according to still another aspect of the present invention is a method for manufacturing a stator for a rotating electrical machine including a rotor and the stator. The stator includes a stator core having a plurality of slots in a direction parallel with a rotating shaft of the rotating electrical machine. The method for manufacturing the stator includes a forming step of forming a conductor plate into an “I”-shaped coil plate in which a first insulating member is attached to at least one side and a paste-like joining material containing a metal nanoparticle coated with an organic substance and an organic solvent is applied to joint faces of two ends, a step of laminating a plurality of “I”-shaped coil plates each equal to the “I”-shaped coil plate described above in a radial direction so as to insert the plurality of “I”-shaped coil plates into a hollow-shaped second insulating member with the first insulating member being interposed between the respective coil plates, a step of inserting, into the slot, the second insulating member that integrally holds coil plate laminated bodies each formed by laminating the plurality of coil plates, a step of incorporating a connection member for connecting between the coil plate laminated bodies inserted into the different slots, and a joining step of joining a contact portion between the coil plate and the connection member while applying pressure and heat until a lapse of a predetermined period of time.

According to the present invention, in the forming step, the conductor plate is formed into the “I”-shaped coil plate in which the first insulating member is attached to at least one side and the paste-like joining material containing the metal nanoparticle coated with the organic substance and the organic solvent is applied to the joint faces of the two ends. The “I”-shaped coil plates are laminated with the first insulating member being interposed therebetween. The plurality of laminated coil plates are held by the second insulating member. For example, a thickness of the first insulating member is set to be not less than a distance capable of ensuring insulation between the coil plates, so that insulating performance between the coil plates can be ensured with certainty by interposition of the first insulating member. Therefore, when the thickness of the first insulating member is made thin as much as possible while ensuring the insulating performance, a space factor can be enhanced without deterioration of the insulating performance. Accordingly, it is possible to provide a method for manufacturing a stator for a rotating electrical machine capable of achieving both improvement of a space factor and insulation between coil turns. Further, the coil plates are inserted into the second insulating member, so that the insulation between the coil plate and the stator core can be achieved by interposition of the second insulating member. Moreover, the laminated coil plates are held integrally. In comparison with a case where the laminated coil plates are integrally molded by a resin, therefore, it is unnecessary to perform a correcting operation such as an operation for cutting a protruding resin. Accordingly, it is possible to provide a method for manufacturing a stator for a rotating electrical machine which suppresses deterioration of workability. Further, the joint portion between the ends of the coil plates and the connection members (e.g., a transition member and a bus bar) is joined with the use of the paste-like joining material containing the metal nanoparticle coated with the organic substance and the organic solvent. In the joining material, when the organic substance serving as a protective layer is decomposed by application of heat, the metal nanoparticle is sintered at a low temperature. Therefore, the sintering temperature can be set to be lower than a melting temperature of an insulating material. On the other hand, after the sintering, the metal nanoparticle is in a metal bonding state, and is not melted until the temperature approaches a eutectic temperature between metal and a material for the coil plate (e.g., about 1000° C. in a case of a eutectic temperature between silver and copper). When the joint portion is joined with the use of the joining material described above, the temperature in the joining process becomes lower than the melting temperature of the insulating material, leading to suppression of deterioration of insulating performance of the insulating member. After the joining process, further, the melting temperature of the joint portion becomes sufficiently higher than the heat generated upon actuation of the rotating electrical machine, leading to suppression of deterioration of a joining strength. Accordingly, it is possible to provide a stator for a rotating electrical machine which suppresses deterioration of insulating performance due to heat generated in a joining process. Further, there is no necessity of cutting a coil end after incorporation into the stator core; therefore, it is possible to suppress damage of insulation caused due to burrs or powders resulting from the cutting process.

Preferably, the forming step includes a step of curing the joining material after application of the joining material until the joining material is set at a tack-free state.

According to the present invention, the joining material (e.g., a silver nanoparticle paste) is cured so as to be in the tack-free state after being applied to the coil plate. For this reason, the surface of the joining material is in a dry state, so that no foreign matters are attached to the joining material at each end of the coil plate. In particular, the surface of the joining material is in the dry state, so that the joining material is not flown from the applied position. At an intermediate stage of a coil plate forming step, therefore, even when the joining material is applied to parts sequentially connected to one another, there is no possibility that the joining material is flown in a subsequent step so as to be displaced from a predetermined application range or a foreign matter is attached to the joining material. It is possible to reduce a processing time in comparison with the case where the joining material is applied to the coil plate after incorporation into the stator core. That is, it is possible to reduce a stator producing time. Moreover, the joining material can be applied at the intermediate stage of the coil plate forming step, which makes it possible to facilitate management of state levels concerning a joining process, such as an application range, an amount, a film thickness and the like of the joining material to be applied. Therefore, it is possible to suppress variation in these state levels.

More preferably, the joining step includes a step of applying heat so as to achieve a predetermined temperature lower than a melting temperature of an insulating material used for the stator.

According to the present invention, the stator is heated to the predetermined temperature lower than the melting temperature of the insulating material to be used for the stator. Thus, there is no possibility that the stator is heated until the insulating material is melded by the heat generated in the joining process, leading to suppression of deterioration of insulating performance.

More preferably, a stator for a rotating electrical machine is manufactured by the method for manufacturing the stator according to the present invention.

According to the present invention, the stator manufacturing method makes it possible to manufacture a stator for a rotating electrical machine which achieves both improvement of a space factor and insulation between coil turns, suppresses deterioration of workability, and suppresses deterioration of insulating performance due to heat generated in a joining process.

### BRIEF DESCRIPTION OF THE DRAWINGS

FIG. 1 is a perspective view of a stator according to the present embodiment.

FIG. 2 is a flowchart showing a procedure of a method for manufacturing the stator according to the present embodiment.

FIG. 3 is a perspective view of a coil plate.

FIG. 4 is a view showing a step of fabricating a coil plate laminated body.

FIG. 5 is a perspective view of a coil sub-assy.

FIG. 6 is an appearance view of the coil sub-assy which is seen in a direction of an arrow mark A in FIG. 5.

FIG. 7 is a view showing a step of incorporating the coil sub-assy into a stator core.

FIG. 8 is a perspective view of the coil sub-assy which has been incorporated into the stator core.

FIG. 9 is a view showing a step of incorporating a transition member laminated body into the coil sub-assy.

FIG. 10A and FIG. 10B are perspective views of a transition member.

FIG. 11A and FIG. 11B are views schematically showing a joint portion between the coil plate and the transition member.

FIG. 12 is a view showing a step of incorporating a bus bar into the coil sub-assy.

FIG. 13 is a view showing a step of incorporating a terminal member into the coil sub-assy.

FIG. 14 is a perspective view of the stator before a joining process.

FIG. 15 is a view showing a direction of applying a pressure to the coil sub-assy.

FIG. 16 is a perspective view of the stator subjected to a resin molding process.

FIG. 17 is a view showing a magnetic flux line generated when AC power is supplied to a rotating electrical machine.

### BEST MODE FOR CARRYING OUT THE INVENTION

Hereinafter, an embodiment of the present invention is described with reference to the drawings. In the following description, identical parts are denoted by identical reference symbols. Designations and functions thereof are the same. Accordingly, detailed description thereof is not repeated.

A stator according to the present embodiment is a stator for a rotating electrical machine constituted of the stator and a rotor including a permanent magnet. In the present embodiment, the stator is a stator for a three-phase AC synchronization rotating electrical machine of which the number of poles is 21. However, the present invention should be applied to a stator around which a coil is wound, and the number of poles is not particularly limited to 21. Further, it should not be understood that the present invention is applied to only the stator for the three-phase AC synchronization rotating electrical machine.

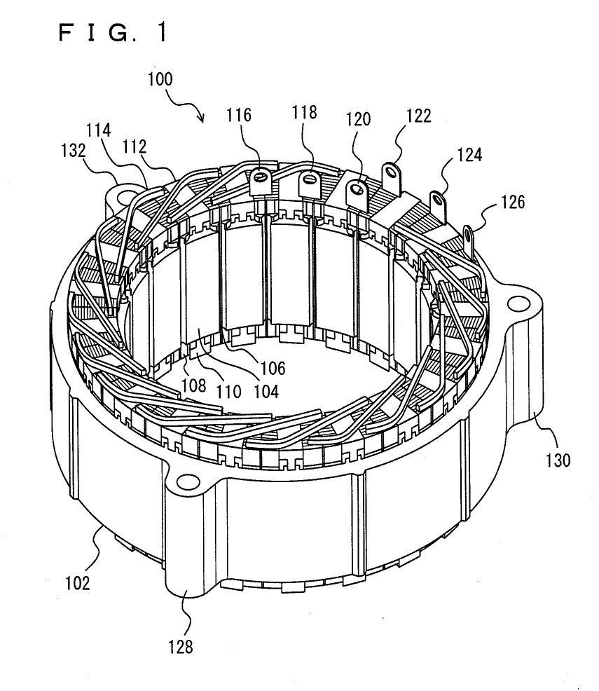

As shown in FIG. 1, a stator 100 is constituted of a stator core 102, a coil sub-assy 108, transition member laminated bodies 110 and 112, and a bus bar 114.

Stator core 102 is formed into a hollow cylindrical shape. In stator core 102, only the predetermined number of through slots 106 extending in a direction parallel with a rotating shaft are formed along a circumferential direction of stator core 102. In stator core 102, further, only the predetermined number of teeth 104 are formed between slots 106 so as to be opposed to an axial center of the rotating shaft. The predetermined number corresponds to the number of poles. In the present embodiment, the number of slots 106 to be formed and the number of teeth 104 to be formed are 21, respectively. In the present embodiment, moreover, stator core 102 is formed in such a manner that a plurality of electromagnetic steel plates are laminated.

Coil sub-assy 108 is inserted into slot 106 formed in stator core 102. Coil sub-assy 108 has a configuration that two sets of coil plate laminated bodies (not shown) are integrally held by a resin insulator (not shown). The coil plate laminated body is formed in such a manner that a plurality of “I”-shaped coil plates are laminated in a radial direction. It is to be noted that the coil plate laminated body is preferably formed in such a manner that the coil plates are laminated from a back yoke side toward an axial center side of stator core 102, and the laminating direction is not particularly limited to the radial direction. For example, the coil plate laminated body may have a configuration that a plurality of “I”-shaped coil plates are laminated such that a width direction of the coil plate is orthogonal to a tooth wall face in the slot.

In the present embodiment, moreover, coil sub-assy 108 has the configuration that the two sets of coil plate laminated bodies, which are different in phase from each other, are integrally held by the resin insulator; however, the number of sets is not particularly limited to two. For example, coil sub-assy 108 may have a configuration that a set of coil plate laminated bodies are integrally held by a resin insulator.

Protrusions 128, 130 and 132 protruding outward in the radial direction are formed on a cylinder-shaped outer peripheral surface of stator core 102. Through holes extending in the direction of the rotating shaft are formed in protrusions 128, 130 and 132, respectively. Stator core 102 is secured to a housing of the rotating electrical machine by fastening of a bolt inserted into the through hole.

In two coil sub-assys 108 inserted into the slots positioned at two sides of tooth 104, the coil plates laminated bodies adjoining to the single tooth are connected to each other by transition member laminated bodies 110 and 112. Transition member laminated body 110 is incorporated into tooth 104 at an upper side of FIG. 1. Transition member laminated body 112 is incorporated into tooth 104 at a lower side of FIG. 1. A coil end is formed by transition member laminated bodies 110 and 112.

Each of transition member laminated bodies 110 and 112 has a configuration that a plurality of transition members are laminated. The transition members connect between ends of the coil plates forming the two coil plate laminated bodies positioned at the two sides of tooth 104 (i.e., inserted into the different slots).

Transition member laminated bodies 110 and 112 are incorporated into the two coil plate laminated bodies positioned at the two sides of tooth 104, so that a coil is spirally wound around tooth 104 by the predetermined number of turns (14 turns in the present embodiment). It is to be noted that winding directions of the coils wound around the respective teeth are the same.

Herein, ends of the coil wound around tooth 104 by 14 turns correspond to an end of the coil plate positioned at a side closest to the axial center and connected to no transition member and an end of the coil plate positioned at a side farthest from the axial center and connected to no transition member.

One end of bus bar 114 is connected to these ends, respectively. The other end of bus bar 114 is connected to ends of single-phase coils wound around the other teeth (i.e., the coil plate laminated bodies inserted into the different slots). In stator core 102, as described above, the coils corresponding to a U phase, a V phase and a W phase are wound around the respective teeth by 14 turns.

Terminal members 116 to 126 are provided at the ends of the coils of the respective phases. Herein, terminal member 116 and terminal member 122 correspond to the ends of the U-phase coil, terminal member 118 and terminal member 124 correspond to ends of the V-phase coil, and terminal member 120 and terminal member 126 correspond to the ends of the W-phase coil.

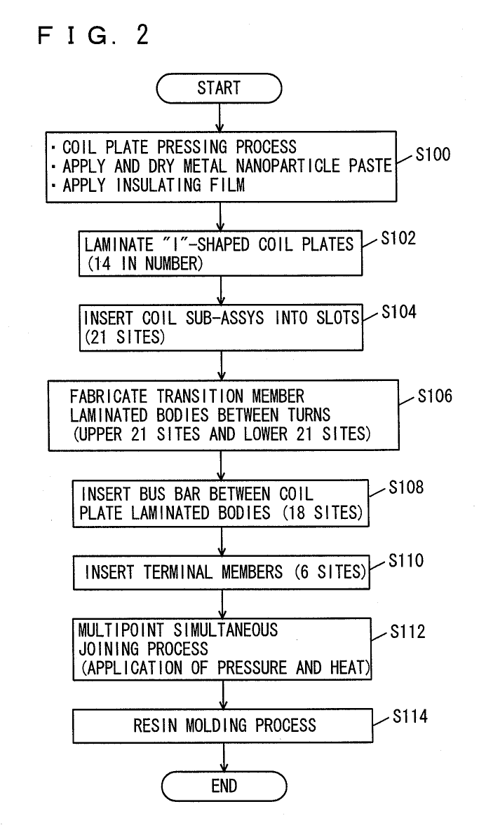

With the use of a flowchart of FIG. 2, hereinafter, a procedure of a method for manufacturing stator 100 according to the present embodiment is described in detail.

In step (hereinafter, the term “step” will be described as “S”) 100, an “I”-shaped coil plate is formed by a pressing process.

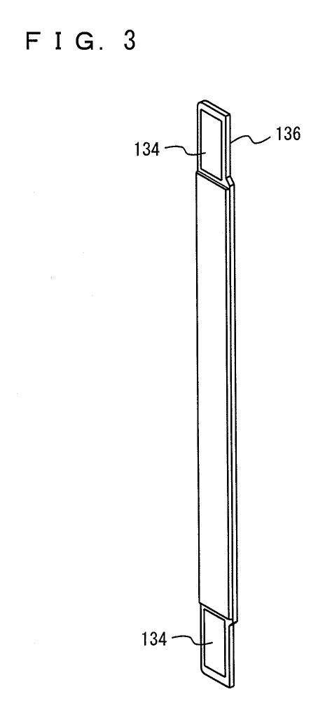

As shown in FIG. 3, a coil plate 136 is formed into an “I” shape in such a manner that a metal plate prepared by rolling a copper material is subjected to the pressing process. Coil plate 136 is formed into the “I” shape by, for example, a shearing process. Copper used as a material for coil plate 136 is high in heat conductivity and, therefore, can improve heat radiation performance of coil plate 136. In addition, copper is low in internal resistance and is high in conductivity when being used as a conductor. Therefore, copper can suppress heat generated when a current density is improved.

Moreover, a step difference having a joint face is formed at each of the two ends of coil plate 136. In the present embodiment, it is assumed that the step difference having the joint face is formed by, for example, a cutting process. In the joint face of coil plate 136, moreover, a joining material is applied onto a predetermined application range 134. In the present embodiment, the joining material is a paste-like joining material (hereinafter, referred to as a metal nanoparticle paste) containing a metal nanoparticle coated with an organic substance and an organic solvent. The metal nanoparticle is a nanoparticle of metal selected from, for example, gold, silver, copper and platinum. In the present embodiment, however, description will be given of use of, for example, a paste-like joining material containing a silver nanoparticle coated with an organic substance and an organic solvent (hereinafter, referred to as a silver nanoparticle paste). As for the silver nanoparticle paste, when the organic substance serving as a protective layer is decomposed by application of heat, the silver nanoparticle is sintered at a low temperature. Therefore, the sintering temperature is low, for example, about 260° C., which is lower than a melting temperature of an insulating material such as PPS (polyphenylene sulfide). On the other hand, after the sintering, the silver nanoparticle is in a metal bonding state and is not melted until the temperature approaches a eutectic temperature (about 1000° C.) of metal silver and copper which is a material for the coil plate. It is to be noted that a joining material containing the metal nanoparticle is a well-known technique; therefore, detailed description thereof will not be given.

The silver nanoparticle paste applied to the joint face is dried so as to be in a tack-free state. Thus, the surface of the silver nanoparticle paste applied to the joint face is cured, so that a flow of the silver nanoparticle paste is suppressed.

Further, an insulating film is attached to at least one side of coil plate 136. It is to be noted that a coating film of insulation coating may be attached in place of the insulating film. A material for the insulating film is not particularly limited as long as the insulating film has a thickness capable of ensuring insulation between coil plates. The insulating film is a polyimide film, for example. The insulating film is applied to at least one of two opposed faces of coil plate 136 in a thickness direction. In the present embodiment, it is assumed that the insulating film is applied to coil plate 136 so as to cover the entire side on which no joint face is formed.

Further, a sectional shape including the thickness and width of the coil plate is formed so as to have a dimension corresponding to the position of the coil plate when being laminated.

More specifically, the coil plate positioned at a side of a back yoke of stator core 102 is formed into a shape so as to have a larger width and a smaller thickness. As described above, the sectional shape of the coil plate is changed in accordance with the position of the coil plate when being laminated, so that the sectional shape of the coil plate laminated body to be inserted into the slot can be set freely. That is, when an area of the sectional shape of the coil plate laminated body is made close to an area of the sectional shape of the slot, a space factor can be improved.

Back to FIG. 2, in S102, the “T”-shaped coil plates are laminated to fabricate coil sub-assy 108.

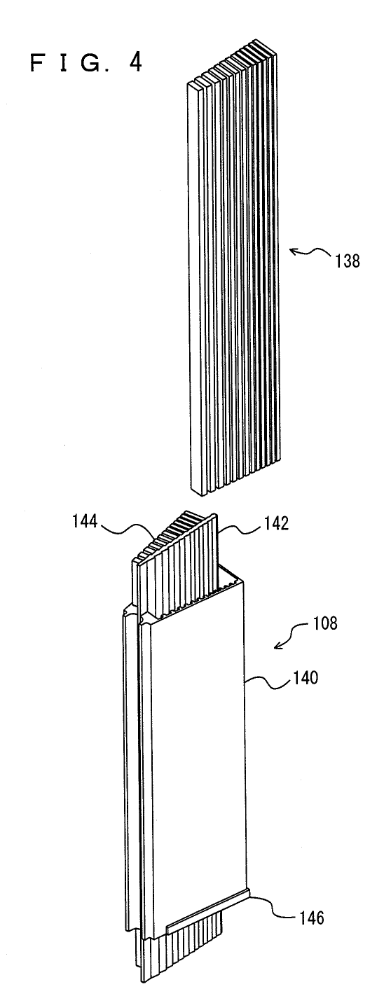

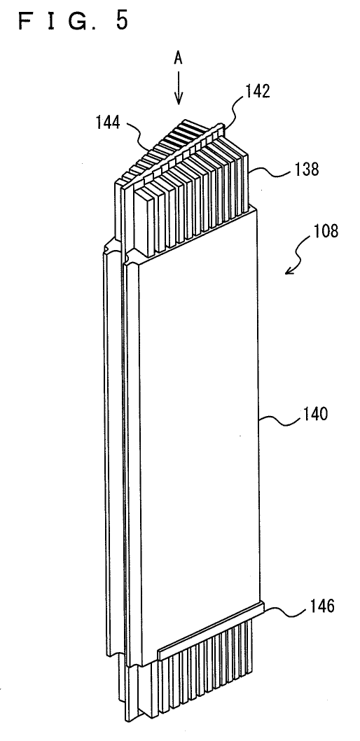

As shown in FIG. 4, coil plate laminated bodies 138 and 144 each formed by the plurality of coil plates are inserted into resin insulator 140 in a longitudinal direction of resin insulator 140 to fabricate coil sub-assy 108 shown in FIG. 5. Herein, the coil plates are laminated in each of coil plate laminated bodies 138 and 144 such that the insulating film is interposed between the two coil plates.

When the plurality of coil plates are inserted into resin insulator 140, the positions thereof are restricted by resin insulator 140. Resin insulator 140 is a hollow insulating member formed so as to contact with an inner wall face of the slot. It is to be noted that, preferably, resin insulator 140 can restrict at least the positions of coil plate laminated bodies 138 and 144 to integrally hold coil plate laminated bodies 138 and 144; therefore, the shape of resin insulator 140 is not particularly limited to the hollow shape.

Examples of a material for resin insulator 140 include epoxy, polyphenylene sulfide (PPS), liquid crystal (LCP), polyetheretherketone (PEEK) and the like, and such a material is molded into a predetermined shape. It is to be noted that the material for resin insulator 140 is not particularly limited to the materials described above as long as it is an insulating material which can be resin-molded.

Further, an insulating plate 142 is formed at a center portion of resin insulator 140 so as to partition coil plate laminated bodies 138 and 144. Insulating plate 142 suppresses contact of two coil plate laminated bodies of different phases in the single slot. Insulating plate 142 allows insulation between the coil plate laminated bodies (the phases) inserted into the single slot.

Further, a protrusion 146 is formed at one of ends of resin insulator 140 in the longitudinal direction so as to protrude along an outer peripheral direction of resin insulator 140.

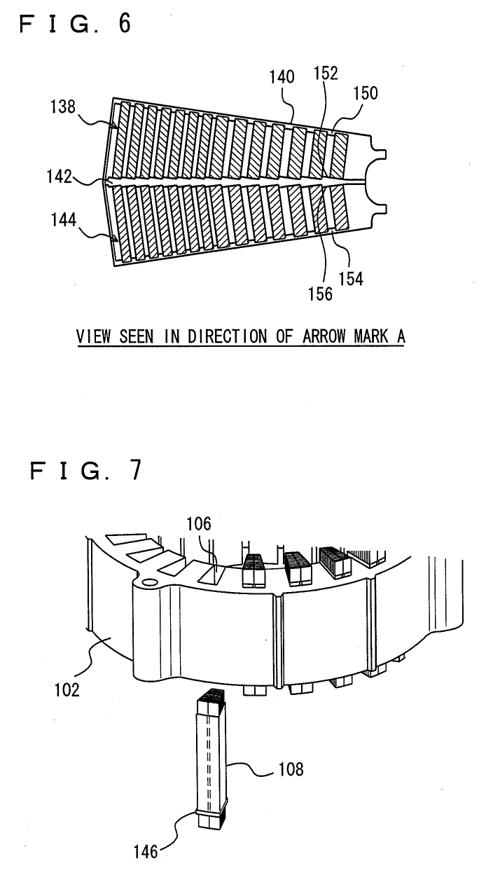

FIG. 6 shows an outer appearance of the coil sub-assy which is seen in a direction of an arrow mark A in FIG. 5. As shown in FIG. 6, a sectional shape of resin insulator 140 is a substantially sector shape formed such that an outer peripheral face thereof contacts with the inner wall face of the slot. Insulating plate 142 divides the inner space of resin insulator 140 into two so as divide a center angle of the substantially sector shape into halves.

At the inner wall face of resin insulator 140 positioned above in FIG. 6, grooves are formed by a plurality of protrusions 150 formed along the longitudinal direction of resin insulator 140. Protrusions 150 are formed with a predetermined space being provided therebetween along the radial direction. A width of the groove between two protrusions 150 corresponds to the thickness of the coil plate to be inserted. Accordingly, protrusions 150 are formed such that the width of the groove becomes wider as it becomes close to the center side of the substantially sector shape along the radial direction. This groove restricts the position of the coil plate (hatched portion) in the thickness direction.

Moreover, a step-shaped protrusion 152 is formed on the surface of insulating plate 142 positioned so as to be opposed to the inner wall face positioned above in FIG. 6. Protrusion 152 has a face parallel with a bottom face of the groove. Protrusion 152 is formed along the longitudinal direction of resin insulator 140. Herein, a distance from the bottom face of the groove to the face of the protrusion 152 formed on insulating plate 142 corresponds to the width of the coil plate to be inserted. Accordingly, a length from the bottom face of the groove to the face of protrusion 152 becomes short as it is closer to the center side of the substantially sector shape in the radial direction. The face of protrusion 152 formed on the insulating plate 142 restricts the position of the coil plate in the width direction.

In the present embodiment, coil plate laminated body 138 is formed by 14 coil plates. Accordingly, the 14 grooves are formed on resin insulator 140 by protrusions 150. Further, 14 protrusions 152 are also formed on insulating plate 142.

It is to be noted that protrusions 154 and 156 are formed at a space of insulating plate 142 positioned below in FIG. 6 in a similar manner to restrict positions of the 14 laminated coil plates forming coil plate 144 in the thickness direction and the width direction. Detailed description thereof will not be given repeatedly here.

Moreover, the plurality of coil plates forming coil plate laminated bodies 138 and 144 are inserted into the grooves corresponding to their respective sectional shapes while being slid on the grooves. As for the plurality of inserted coil plates, the position in an inserting direction is restricted by resin insulator 140 and the inner wall face of insulating plate 142.

That is, when coil plate laminated body 138 is inserted into resin insulator 140, protrusion 150, the groove between two protrusions 150, and protrusion 152 formed on insulating plate 142 hold coil plate laminated body 138. Therefore, the position of the coil plate laminated body 138 in the inserting direction is restricted by a frictional force. It is to be noted that “L”-shaped bent portions or protrusions may be formed on ends of the respective coil plates forming the coil plate laminated body in order to restrict the position in the inserting direction.

Back to FIG. 2, in S104, coil sub-assy 108 is inserted into slot 106. As shown in FIG. 7, coil sub-assy 108 is inserted into slot 106 from a bottom side of stator core 102 in FIG. 7 in a state that an end of resin insulator 140 on which protrusion 146 is formed is directed downward.

In stator core 102, recess-shaped portions (not shown) which can be engaged with protrusions 146 are formed so as to be open from a side of slot 106 in the downward direction in FIG. 7. That is, when coil sub-assy 108 is inserted into stator core 102, protrusions 146 and the recess shapes are engaged with one another. Thus, the movement of coil sub-assy 108 in an upward direction in FIG. 7 is restricted. Coil sub-assys 108 are inserted into all the slots (21 sites) formed on stator core 102.

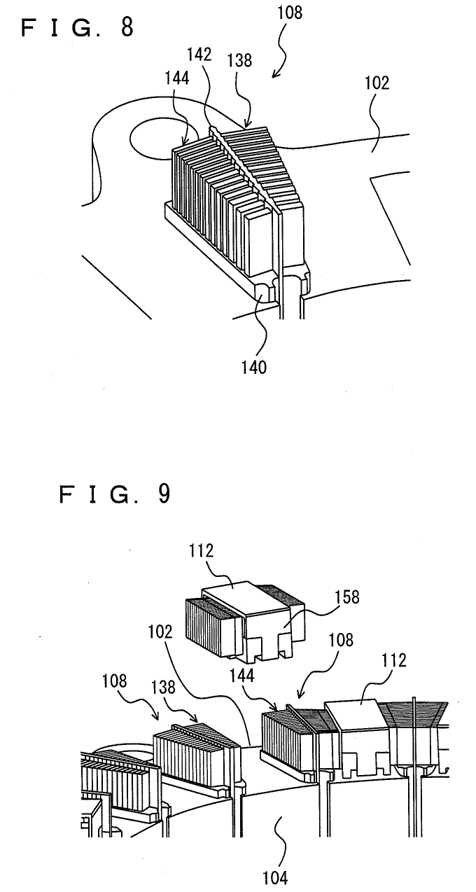

As shown FIG. 8, when coil sub-assy 108 is inserted into stator core 102, the positions of coil plate laminated bodies 138 and 144 in the radial direction, the circumferential direction and the axial direction are restricted by resin insulator 140. Further, resin insulator 140 prevents coil plate laminated bodies 138 and 144 from directly contacting with stator core 102.

Back to FIG. 2, in S106, the transition members are inserted so as to connect between the ends of the respective coil plates forming coil plate laminated bodies 138 and 144.

As shown in FIG. 9, transition member laminated body 112 is incorporated into the upper portion of tooth 104 and transition member laminated body 110 is incorporated into the lower portion of tooth 104 so as to connect between coil plate laminated bodies 138 and 144 inserted into the two sides of tooth 104 while being opposed to each other.

At a lower side in FIG. 9, the transition members forming transition member laminated body 110 connect between the ends of the two coil plates positioned so as to be opposed to each other with tooth 104 being interposed therebetween.

At an upper side in FIG. 9, on the other hand, the transition members forming transition member laminated body 112 connect between the one of the ends of the two coil plates positioned so as to be opposed to each other with tooth 104 being interposed therebetween and the end of the coil plate adjoining to the other end at the back yoke side.

When the transition members connect between the ends of the respective coil plates positioned as described above, the coil is spirally wound around tooth 104 by the predetermined number of turns (14 turns in the present embodiment).

In each of transition member laminated bodies 110 and 112, the plurality of transition members (hereinafter, also referred to as coil end plates) are laminated and are integrally held by a holding member 158 made of an insulating material. Holding member 158 may integrate the central portions of the plurality of laminated transition members into one by resin molding or the like. Alternatively, holding member 158 may integrally hold the central portions of the plurality of laminated transition members.

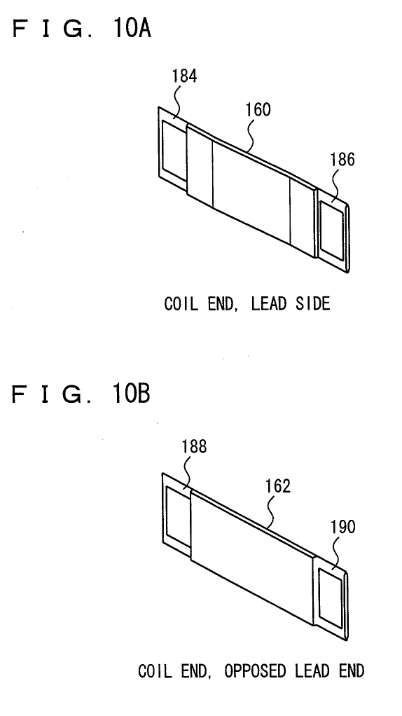

Transition member 160 shown in FIG. 10A is the coil end plate forming transition member laminated body 112. Transition member 160 is the coil end plate on the side (lead side) having the end of the coil plate to be connected to one end of bus bar 114.

Step differences having joint faces 184 and 186 are formed on the two ends of transition member 160. In each of joint faces 184 and 186 at the two ends of transition member 160, the silver nanoparticle paste is applied to a predetermined application range. The silver nanoparticle paste is applied in a step of performing a pressing process on transition member 160. It is to be noted that the silver nanoparticle paste may be applied to one of the joint face at the end of transition member 160 and the joint face at the end of coil plate.

On the other hand, transition member 162 shown in FIG. 10B is the coil end plate forming transition member laminated body 110. Transition member 162 is the coil end plate on the side (opposed lead side) having no end of the coil plate connected to bus bar 114.

Step differences having joint faces 188 and 190 are formed on the two ends of transition member 162. In each of joint faces 188 and 190 at the two ends of transition member 162, the silver nanoparticle paste is applied to a predetermined application range. The silver nanoparticle paste is applied in a step of performing a pressing process on transition member 162. It is to be noted that the silver nanoparticle paste may be applied to one of the joint face at the end of transition member 162 and the joint face at the end of coil plate.

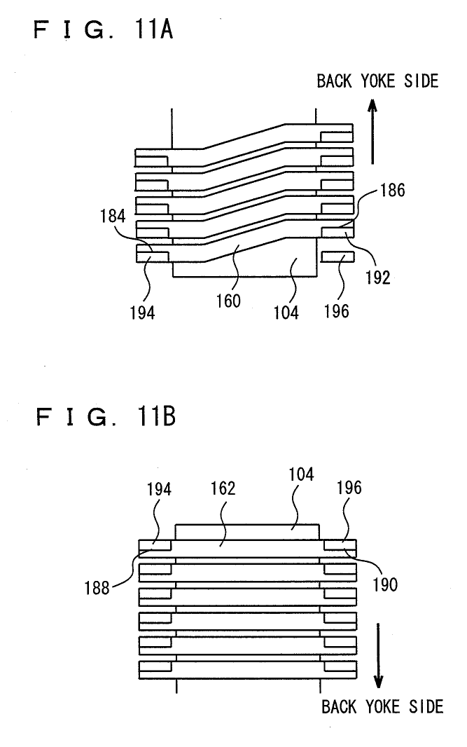

As shown in the figure that schematically shows the joint portion between the coil plate and the transition member in FIG. 11A, joint faces 184 and 186 formed at the two ends of transition member 160 have such a positional relation that at least one of the joint faces is moved laterally by a predetermined distance from a single plane of the other one of the joint faces. Accordingly, transition member 160 joins the end of coil plate 194 to the end of coil plate 192 adjoining to coil plate 196 at the back yoke side in such a positional relation that coil plate 194 is opposed to coil plate 192 with tooth 104 being interposed therebetween.

It is to be noted that the thicknesses of the laminated coil end plates are different in accordance with the position in the slot in the radial direction. Therefore, the distance between joint faces 184 and 186 at the two ends of transition member 160 varies in accordance with the thickness of the coil plate to be connected.

Transition member laminated body 112 has a configuration that 13 transition members 160 are laminated. Herein, 13 transition members 160 are positioned and integrally held by holding member 158 so as to contact with the ends of the corresponding coil plates, respectively.

As shown in the figure of FIG. 11B, on the other hand, joint faces 188 and 190 at the two ends of transition member 162 are in one plane. Accordingly, transition member 162 connects between the ends of two coil plates 194 and 196 which are positioned so as to be opposed to each other with tooth 104 being interposed therebetween.

Transition member laminated body 110 has a configuration that 14 transition members 162 are laminated. Herein, 14 transition members 162 are positioned and integrally held by the holding member so as to contact with the ends of the two coil plates positioned so as to be opposed to each other with tooth 104 being interposed therebetween.

Accordingly, when upper 21 transition member laminated bodies 110 and lower 21 transition member laminated bodies 112 are incorporated into stator core 102, as for the coil plates and the transition member in a predetermined positional relation, the predetermined joint faces of the coil plates of coil plate laminated bodies 138 and 144 contact with the joint faces of the two ends of the transition member. It is to be noted that, in the present embodiment, the joint face of the end of the coil plate is directed outward in the radial direction of stator core 102 and the joint face of the transition member is directed inward in the radial direction.

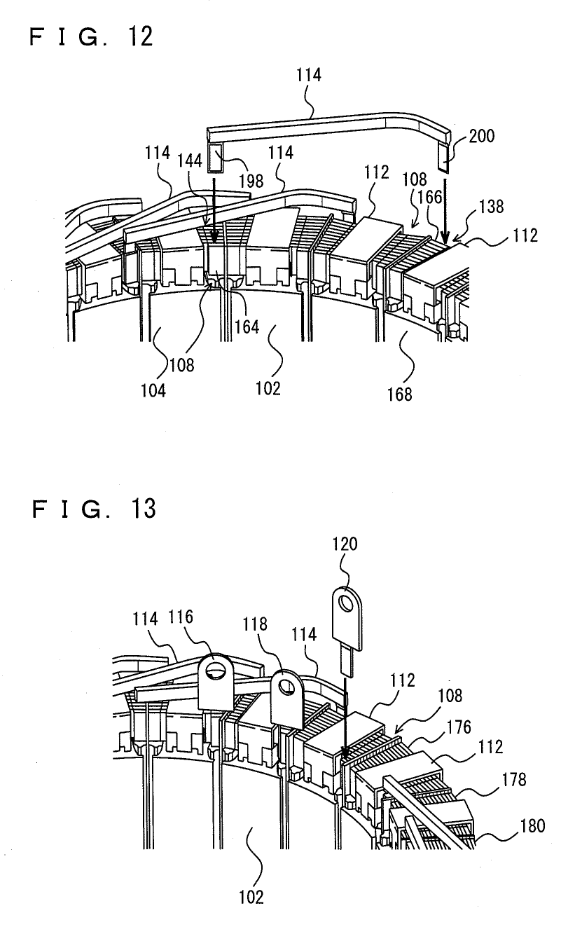

Back to FIG. 2, in S108, bus bar 114 is inserted into the end of the coil plate. As shown in FIG. 12, transition member laminated bodies 110 and 112 are incorporated between all coil sub-assys 108 (upper 21 sites and lower 21 sites), and then bus bars 114 are incorporated into coil sub-assys 108.

More specifically, bus bar 114 has a rod-like shape. “L”-shaped protrusions having joint faces 198 and 200, respectively, are formed at two ends of bus bar 114. Bus bar 114 is bent so as to have such a predetermined shape that joint faces 198 and 200 at the two ends thereof contact with the joint faces at the two ends of the coil plates of respective coil plate laminated bodies 138 and 144.

Herein, 18 bus bars 114 connect among coils wound around teeth with three teeth being interposed therebetween. Bus bar 114 is incorporated such that one end thereof contacts with end 164 of the coil plate, which is closest to the axial center, of the coil plates forming the coils wound around teeth 104. In other words, bus bar 114 is incorporated such that one end thereof contacts with end 164 of the coil plate, which is closest to the axial center, of coil plate laminated body 144. Coil end 160 is an end which is not connected with transition member 160.

Bus bar 114 is incorporated such that the other end thereof contacts with end 166 of the coil plate, which is farthest from the axial center, of the coils wound around tooth 168 separated from tooth 104 by a distance corresponding to three teeth. In other words, bus bar 114 is incorporated such that the other end thereof contacts with end 166 of the coil plate, which is farthest from the axial center, of coil plate laminated body 138. End 166 is an end which is not connected with transition member 160.

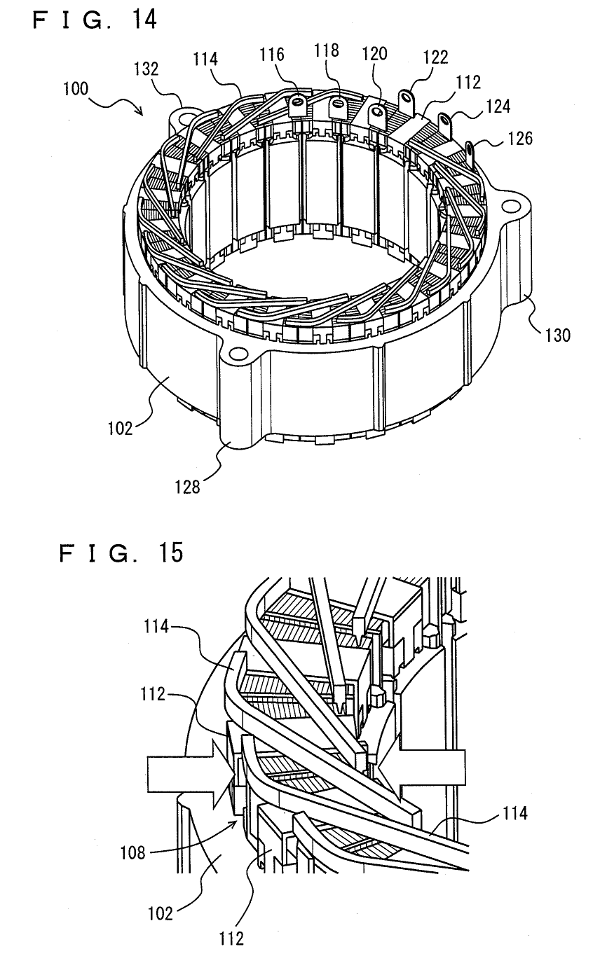

Back to FIG. 2, in S110, terminal members 116 to 126 are incorporated into the ends of the coils. As shown in FIG. 13, terminal members 116, 118 and 120 are incorporated into ends 170, 172 and 174 of the coil plates, which are closest to the axial center and are connected with neither bus bar 114 nor transition member 160, in coil sub-assy 108 inserted into stator core 102, respectively. It is to be noted that the joint faces of ends 170, 172 and 174 of the coil plates, which are closest to the axial center, are directed outward in the radial direction. Therefore, the joint faces of terminal members 116, 118 and 120 are incorporated while being inserted between ends 170, 172 and 174 and ends of coils adjoining to one another in the radial direction, respectively.

Moreover, terminal members 122, 124 and 126 are incorporated into ends 176, 178 and 180 of coil plates which are farthest from the axial center and are connected with neither bus bar 114 nor transition member 160, respectively. The joint faces at the ends of the coil plates which are farthest from the axial center are directed outward in the radial direction. Therefore, terminal members 122, 124 and 126 are incorporated while being positioned by temporary joint or the like.

As described above, coil sub-assy 108 is incorporated into slot 106 of stator core 102, transition member laminated bodies 110 and 112 are incorporated between coil sub-assys 108, and bus bar 114 and terminal members 116 to 126 are incorporated, so that stator 100 before a joining process is fabricated as shown in FIG. 14.

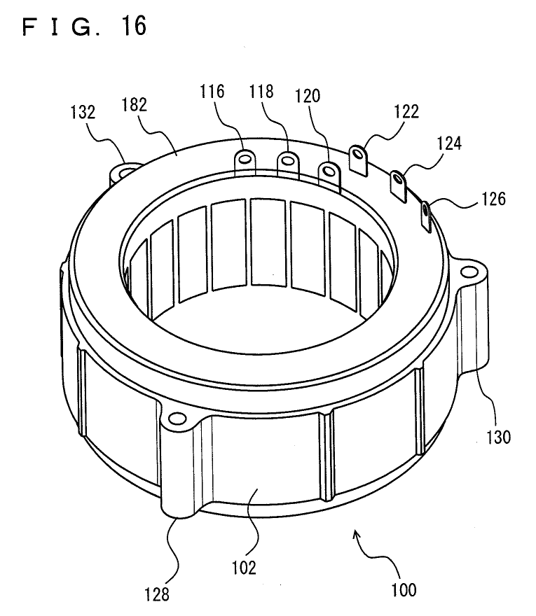

Back to FIG. 2, in S112, a multipoint simultaneous joining process is performed. More specifically, a process of joining contacted joint faces to each other is performed on fabricated stator 100. That is, as shown in FIG. 15, the multipoint simultaneous joining process is performed in such a manner that pressure is applied to the coil ends of all the coil plate laminated bodies, in which bus bar 114 or terminal members 116 to 126 and transition member laminated bodies 110 and 112 are incorporated, from two sides (directions of arrow marks in FIG. 15) in the radial direction, and then heat is applied thereto.

When the temperature increases by the heat, the protective layer with which the silver nanoparticle contained in the silver nanoparticle paste is coated is decomposed, so that the silver nanoparticle is sintered. Moreover, by the application of the pressure, gas and the like in the paste, which are generated when the protective layer is decomposed, are removed from the joint portion. The joint portion is joined by metal bonding that the silver nanoparticle paste is sintered. After the joining process, therefore, the joint portion is not melted until the temperature increases to about 1000° C. corresponding to a melting point of metal silver. It is to be noted that the protective layer with which the silver nanoparticle is coated is decomposed at about 260° C.; therefore, the metal nanoparticle is sintered at a low temperature after the protective layer is decomposed at about 260° C. Accordingly, the application of the heat is continued until the temperature reaches a predetermined temperature, for example, about 260° C. which is lower than a temperature at which an insulating film applied to the coil plate or resin insulator 140 is melted. Therefore, there is no possibility that the insulating film and resin insulator 140 are melted.

Back to FIG. 2, in S114, a resin molding process is performed. As shown in FIG. 16, the molding process is performed in such a manner that the coil end portion of stator 100 after completion of joining of the joint faces is subjected to injection molding using a resin or the like. Herein, a portion other than the outer peripheral face of stator core 102 and the terminals of terminal members 116 to 126 is coated with a resin 182.

In the rotating electrical machine including stator 100 completed as described above and the rotor (not shown), AC power is supplied to each of terminal members 116 to 126, so that a magnetic field is generated in accordance with the supplied power. The rotor rotates by obtaining a rotating force on the basis of the generated magnetic field.

As described above, in the stator for the rotating electrical machine according to the present embodiment, when the thickness of the insulating film becomes larger than the distance ensuring the insulation between the coil plates, the insulating performance between the coil plates in the coil sub-assy can be ensured with certainty by the interposition of the insulating film. Therefore, when the thickness of the insulating film is made smaller as much as possible while ensuring the insulating performance, a space factor can be enhanced without deteriorating insulating performance. Accordingly, it is possible to provide a stator for a rotating electrical machine capable of achieving both improvement of a space factor and insulation between coil turns, and a part used for the stator. The improvement of the space factor allows miniaturization of the size of the stator core.

Further, the coil plate is inserted into the resin insulator. As a result, since the laminated coil plates are held integrally, a correcting operation such as an operation for cutting of a protruding resin becomes unnecessary in comparison with the case where the laminated coil plates are integrally molded by a resin. Accordingly, it is possible to provide a stator for a rotating electric machine capable of suppressing deterioration of workability.

Moreover, the coil plate laminated bodies are integrally held by the resin insulator. Therefore, it is possible to inspect an insulating state between the coil plates laminated before the resin insulator is inserted into the slot. This improves the reliability of insulation between the turns. Further, the resin insulator integrally holds the multi-phase coil plate laminated bodies in the single slot. Therefore, it is possible to inspect the insulating state between the coil plate laminated bodies before the resin insulator is inserted into the slot. This improves reliability of insulation between the phases. Further, it is possible to inspect the insulating performance of the resin insulator before the resin insulator is inserted into the slot. This improves reliability of insulation between the coil plate and the stator core. Moreover, the workability can be improved because the insulating state of the coil plate laminated body held by the resin insulator can be inspected before incorporation into the stator core. Since a coil plate sub-assy which is insufficient in insulation can be removed before incorporation into the stator core, the resultant stator is sufficient in insulation without fail.

Further, the coil plate is formed into the “I” shape by a shearing process or the like, leading to improvement of a yield. Further, the coil end is not necessarily subjected to a cutting process after incorporation into the stator core, leading to suppression of damage of insulation due to burrs or powders resulting from the cutting process.

Further, the joint portion between the end of the coil plate and the transition member and the joint portion between the coil plate and the bus bar are joined by the silver nanoparticle paste. As for the silver nanoparticle paste, when the organic substance is decomposed by application of heat, the silver nanoparticle is sintered at a low temperature. Herein, the sintering temperature is about 260° C. which is lower than a melting temperature of an insulating material such as PPS. On the other hand, after the sintering, the silver nanoparticle joins between the coil plate and the transition member or the bus bar by metal bonding. Therefore, the silver nanoparticle is not melted until the temperature approaches the eutectic temperature between the metal silver and the coil plate. As described above, when the joint portion is joined by the silver nanoparticle paste, the temperature at in the joining process becomes lower than the melting temperature of the insulating material used for the stator; therefore, deterioration of the insulating performance of the insulating member can be suppressed. After the joining process, further, the melting temperature of the joint portion becomes sufficiently higher than the heat generated in a heat cycle upon actuation of the rotating electrical machine; therefore, the deterioration of the joining strength can be suppressed. Accordingly, it is possible to provide a stator for a rotating electrical machine that suppresses deterioration of insulating performance due to heat generated in a joining process.

Moreover, the “I”-shaped coil plate is inserted into the resin insulator; therefore, the resin insulator insulates between the coil plate and the stator core with more certainty. In addition, the joint portion is joined with the use of the silver nanoparticle paste; therefore, no heat is applied until the temperature becomes high in the joining process. For this reason, a resin (such as a PPS resin) which is excellent in moldability can be used as the resin insulator.

Further, the silver nanoparticle paste is cured so as to be in a tack-free state after being applied to the coil plate. For this reason, the surface of the silver nanoparticle paste is in a dry state, so that no foreign matters are attached to the silver nanoparticle paste at each end of the coil plate. In particular, the surface of the silver nanoparticle paste is in the dry state, so that the silver nanoparticle paste is not flown from the applied position. Moreover, the silver nanoparticle paste is not sintered (metal bonding) in view of characteristics thereof until the protective layer for covering the silver nanoparticle is decomposed. At an intermediate stage of a coil plate forming step, therefore, even when the silver nanoparticle paste is applied to parts sequentially connected to one another, there is no possibility that the silver nanoparticles are flown in a subsequent step or a foreign matter is attached to the silver nanoparticle paste. This configuration is allowed to reduce an operating time in comparison with the case where the joining material is applied to the coil plate after incorporation into the stator core. That is, this configuration is allowed to reduce a stator producing time. Moreover, the silver nanoparticle paste can be applied at the intermediate stage of the coil plate forming step, which makes it facilitate management of state levels concerning the joining process, such as an application range, an amount, a film thickness and the like of the silver nanoparticle paste to be applied. Therefore, it is possible to suppress variation in these state levels.

Further, as for the joint portion between the coil plate and the bus bar and the joint portion between the terminal member and the transition member, pressure and heat are applied in the radial direction so as to hold each joint portion, so that the two ends can be joined without significant deformation of the coil plate. Further, pressure and heat are applied in the radial direction or the protruding direction of the tooth, so that joint portions of the plurality of turns can be joined simultaneously.

Further, the coil plate and the transition member are joined almost perpendicularly. Therefore, the coil end is prevented from protruding in the axial direction. As a result, the coil end can be reduced in size. Thus, the rotating electrical machine can be reduced in size.

In the coil plate laminated body, moreover, the plurality of coil plates are laminated to reduce an eddy current loss. Eddy current loss We can be expressed by an equation, We=K (proportionality factor)×t2 (plate thickness). That is, as the thickness of the coil plate through which the electric current passes is larger, the eddy current loss tends to be higher. In order to solve this disadvantage, the laminated body obtained by laminating the plurality of coil plates allows the electric current to pass through each coil plate having a small thickness. As a result, the eddy current loss can be reduced. By the reduction of the eddy current loss, the power loss caused by a leakage flux can be reduced. In addition, the eddy current is reduced by laminating the coil plates, so that a voltage to be applied to the coil plate between the turns can be made low. Thus, it is possible to provide a stator for a rotating electrical machine which is high in space factor and reduces power loss caused due to a leakage flux.

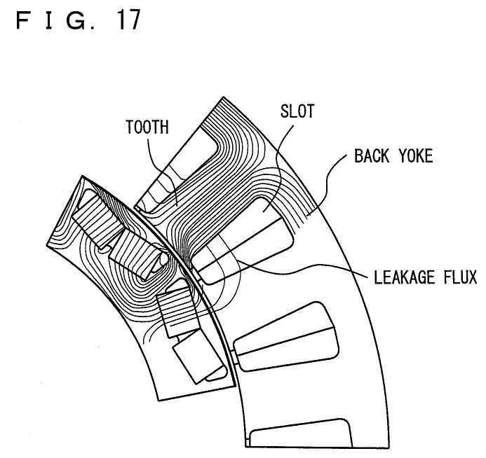

As shown in FIG. 17, further, a magnetic flux is generated when AC power is supplied to the rotating electrical machine according to the present embodiment. Under a high load, a large amount of magnetisms are leaked from the back yokes provided at the tooth and the slot in the outer peripheral direction in the slot of the rotating electrical machine. In accordance with the leakage flux, an eddy current is generated at the coil. This eddy current can be reduced considerably when the coil plate laminated body obtained by laminating the plurality of coil plates is used as the coil. However, the leakage flux is also generated in the direction orthogonal to the face with which the tooth and the coil contact. Therefore, the coil plates are laminated along the radial direction or are laminated such that the faces thereof in the width direction are orthogonal to the tooth wall face in the slot, so that the width direction of the coil plate can be made substantially parallel with the direction of the leakage flux. Therefore, the leakage flux is flown into each coil plate forming the coil plate laminated body. Thus, the eddy current can be reduced.

In a case where the number of poles exceeds a certain number, as for an area of the coil contacting with the electromagnetic steel plate forming the stator core, the tooth side is much larger than the back yoke side. Moreover, heat released from the conductor placed in the vicinity of the center of the slot in the motor around which a typical copper wire is wound is transmitted to the tooth and the back yoke through an enamel layer at several times. This enamel layer largely reduces a heat conductivity. In the present embodiment, however, the heat generated in the vicinity of the center of the slot can also be transmitted to the portion in the vicinity of the electromagnetic steel plate through the inside of the copper which is high in heat conductivity. As a result, a current density can be improved. As described above, an area ratio in the tooth side is larger than an area ratio in the back yoke side; therefore, the heat can be readily released from the coil to the electromagnetic steel plate.

It should be understood that the embodiment disclosed herein is in all aspects illustrative and not restrictive. The scope of the present invention is defined by the appended claims rather than by the foregoing description, and all changes that fall within metes and bounds of the claims, or equivalence of such metes and bounds thereof are therefore intended to be embraced by the claims.

1. A component to be used for a stator, comprising “I”-shaped coil plates each having at least one side to which a first insulating member is attached,
the component being formed in such a manner that the plurality of coil plates each of which is inserted into a single slot of a stator core are laminated and, further, the plurality of laminated coil plates are held by a second insulating member.

2. A stator for a rotating electrical machine including a rotor and the stator, comprising:
a stator core having a plurality of slots in a direction parallel with a rotating shaft of said rotating electrical machine; and
a coil plate laminated body ( ) formed in such a manner that a plurality of “I”-shaped coil plates each having at least one side to which a first insulating member is attached are laminated in a radial direction, wherein
said coil plate laminated bodies are integrally held by a second insulating member inserted into said slot in such a manner that the plurality of coil plates are inserted into said second insulating member with said first insulating member being interposed therebetween, and
said second insulating member integrally holds the multi-phase coil plate laminated bodies in the single slot.

3. The stator for the rotating electrical machine according to claim 2, wherein
said stator further comprises a connection member which connects between the coil plate laminated bodies inserted into the different slots, and
a paste-like joining material containing a metal nanoparticle coated with an organic substance and an organic solvent joins between said coil plate and said connection member.

4. The stator for the rotating electrical machine according to claim 3, wherein said joining material is sintered at a temperature lower than a melting temperature of an insulating material used for said stator.

5. The stator for the rotating electrical machine according to claim 3, wherein said metal nanoparticle is a nanoparticle of metal selected from gold, silver, copper and platinum.

6. The stator for the rotating electrical machine according to claim 2, wherein said first insulating member is any one of an insulating film and a coating film of insulation coating.

7. The stator for the rotating electrical machine according to claim 2, wherein said second insulating member is formed into a hollow shape which contacts with an inner wall face of said slot and extends in a direction parallel with said rotating shaft, and is formed into a predetermined shape by a resin.

8. The stator for the rotating electrical machine according to claim 2, wherein said coil plate laminated body includes a plurality of coil plates laminated in the radial direction.

9. The stator for the rotating electrical machine according to claim 2, wherein said coil plate laminated body ( ) includes a plurality of coil plates laminated such that a width direction of the coil plate is orthogonal to a wall face in said slot in a circumferential direction.

10. A method for manufacturing a stator for a rotating electrical machine including a rotor and the stator, said stator including a stator core having a plurality of slots in a direction parallel with a rotating shaft of said rotating electrical machine, the method comprising:
a forming step of forming a conductor plate into an “I”-shaped coil plate in which a first insulating member is attached to at least one side and a paste-like joining material containing a metal nanoparticle coated with an organic substance and an organic solvent is applied to joint faces of two ends;
a step of laminating a plurality of “I”-shaped coil plates each equal to said “I”-shaped coil plate in a radial direction so as to insert said plurality of “I”-shaped coil plates into a hollow-shaped second insulating member with the first insulating member being interposed between the respective coil plates;
a step of inserting, into said slot, said second insulating member that integrally holds coil plate laminated bodies each formed by laminating said plurality of coil plates;
a step of incorporating a connection member for connecting between the coil plate laminated bodies inserted into the different slots; and
a joining step of joining a contact portion between said coil plate and said connection member while applying pressure and heat until a lapse of a predetermined period of time.

11. The method for manufacturing the stator according to claim 10, wherein said forming step includes a step of curing said joining material after application of said joining material until said joining material is set at a tack-free state.

12. The method for manufacturing the stator according to claim 10, wherein said joining step includes a step of applying heat so as to achieve a predetermined temperature lower than a melting temperature of an insulating material used for said stator.

13. A stator for a rotating electrical machine, which is manufactured by the method for manufacturing the stator according to claim 10.

14. The part to be used for the stator according to claim 1, wherein
said second insulating member is formed into a hollow shape,
said plurality of laminated coil plates are integrally held by said second insulating member, and
an interior of said second insulating member is formed so as to restrict positions of said plurality of laminated coil plates in an inserting direction by holding said plurality of laminated coil plates.

15. The rotor for the rotating electrical machine according to claim 2, wherein
said second insulating member is formed into a hollow shape, and
an interior of said second insulating member is formed so as to restrict positions of said plurality of laminated coil plates in an inserting direction by holding said plurality of laminated coil plates.

16. The method for manufacturing the stator according to claim 10, wherein an interior of said second insulating member is formed so as to restrict positions of said plurality of laminated coil plates in an inserting direction by holding said plurality of laminated coil plates.
